(19) United States
(12) Patent Application Publication
(10) Pub. No.: US 2011/0018335 A1
(43) Pub. Date: Jan. 27, 2011

(54) WHEEL COMPONENT COVERING

(76) Inventor: Frank J. Hodges, Yorba Linda, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/840,972

(22) Filed: Jul. 21, 2010

Related U.S. Application Data
(60) Provisional application No. 61/227,398, filed on Jul. 21, 2009.

(51) Int. Cl. B60B 7/01; B60B 1/06; B23P 11/00

(52) U.S. Cl. 301/37.24; 29/428; 29/525.01

(57) ABSTRACT

Some embodiments disclosed herein related to a wheel component covering. The wheel component covering can attach to an outboard rim flange of a wheel, and a lip portion of the wheel component covering can extend in the inboard direction. In some embodiments, the wheel component covering can attach to the inboard or outboard side of a register of the wheel using bolts or screws. In some embodiments, the wheel component covering can attach to the wheel barrel using bolts or screws, and a covering can be positioned to conceal the bolts or screws. Some wheel component coverings can have gaps configured to receive the spokes of the wheel. The wheel component covering can be used to give a one-piece wheel the appearance of being a multi-piece wheel (e.g., a two- or three-piece wheel).

### RELATED APPLICATIONS

This application claims the benefit under 35 U.S.C. §119(e) of U.S. Provisional Patent Application No. 61/227,398, filed on Jul. 21, 2009, titled WHEEL COMPONENT COVERING, the entirety of which is hereby incorporated by reference herein.

### BACKGROUND OF THE DISCLOSURE

1. Field of the Disclosure

Embodiments of the invention relate generally to automotive wheels and specifically to automotive wheel components.

2. Background

Some automotive wheels include attachments to an outboard surface to enhance the appearance of the wheels and/or to provide structural or other functional advantages. Current attachments suffer from various drawbacks. For example, in many cases, these attachments can be difficult to firmly secure to the wheel while providing a desired appearance. For example, existing wheel rim flange coverings do not securely and reliably attach to a wheel in a way that is removable and provides an acceptable aesthetic appearance.

### SUMMARY OF SOME EMBODIMENTS

By way of example, and not limitation, in some embodiments, wheel rim flange coverings can securely attach to the rim flange using one or more of the existing structures on the flange and/or other components of the wheel. For example, in some embodiments, a wheel rim flange covering can contact an outer region of the rim flange on a first, radially outward side and the wheel rim flange can contact a register of a wheel on a second, radially inward side. In some embodiments, the wheel rim flange covering is a generally circular, stainless steel wheel component.

A wheel configured to be mounted onto a vehicle is disclosed. The wheel can include a wheel barrel having a radially inner surface, an inboard side, and an outboard side. The wheel can include an outboard rim flange positioned on the outboard side of the wheel barrel. The wheel can include a wheel center having a hub and a plurality of spokes connecting the hub to the wheel barrel. The wheel can include a wheel component covering. The wheel component covering can include an outboard portion secured to the outboard rim flange, a lip portion extending from the outboard portion along the radially inner surface of the wheel barrel toward the inboard side of the wheel barrel, and a plurality of gaps formed in the lip portion. The plurality of spokes can be received by the plurality of gaps.

A wheel component covering is disclosed. The wheel component covering can include an outboard portion configured to attach to an outboard rim flange of a wheel, a lip portion configured to extend from the outboard portion along a radially inner surface of a wheel barrel of the wheel toward the inboard side of the wheel barrel, and a plurality of gaps formed in the lip portion. The plurality gaps can be configured to receive a plurality of spokes of the wheel.

A method of attaching a wheel component covering to a wheel is disclosed. The method can include providing a wheel. The wheel can include a wheel barrel having a radially inner surface, an inboard side, and an outboard side. The wheel can include an outboard rim flange positioned on the outboard side of the wheel barrel. The wheel can include a wheel center having a hub and a plurality of spokes connecting the hub to the wheel barrel. The method can include attaching an outboard portion of the wheel component covering to the outboard rim flange. The method can include positioning a lip portion of the wheel component covering along the radially inner surface of the wheel barrel. The method can include receiving the plurality of spokes into a plurality of gaps formed in the lip portion of the wheel component covering.

### BRIEF DESCRIPTION OF THE DRAWINGS

Certain embodiments of the inventions will now be discussed in detail with reference to the following figures. These figures are provided for illustrative purposes only, and the inventions are not limited to the subject matter illustrated in the figures.

FIG. 1 is a partial vertical cross sectional view of an example embodiment of an automotive wheel illustrating an upper outboard portion of the wheel.

FIG. 2 is a partial cross sectional view of another embodiment of a wheel and wheel component covering.

FIG. 3 is a perspective exploded view of another example embodiment of a wheel and wheel component covering.

FIG. 4 is a partial cross sectional view of an example embodiment of the wheel and wheel component covering of FIG. 3.

FIG. 5 is a perspective view of another example embodiment of a wheel component covering.

FIG. 6 is a perspective view of another example embodiment of a wheel component covering.

FIG. 7 is a outboard side view of an example embodiment of a wheel configured to have the wheel component covering attach to the inboard side of the register.

FIG. 8 is a partial cross sectional view of the wheel of FIG. 7 and with the wheel component covering of FIG. 6 attached thereto.

FIG. 9 is another partial cross sectional view of the wheel of FIG. 7 and with the wheel component covering of FIG. 6 attached thereto.

FIG. 10 is a partial perspective, cross sectional view of another example embodiment of a wheel component covering.

FIG. 11 is a partial cross sectional view of a wheel with the wheel component covering of FIG. 10 attached thereto.

FIG. 12 is a partial cross sectional view of another embodiment of a wheel and wheel component covering.

### DETAILED DESCRIPTION OF SOME EXAMPLE EMBODIMENTS

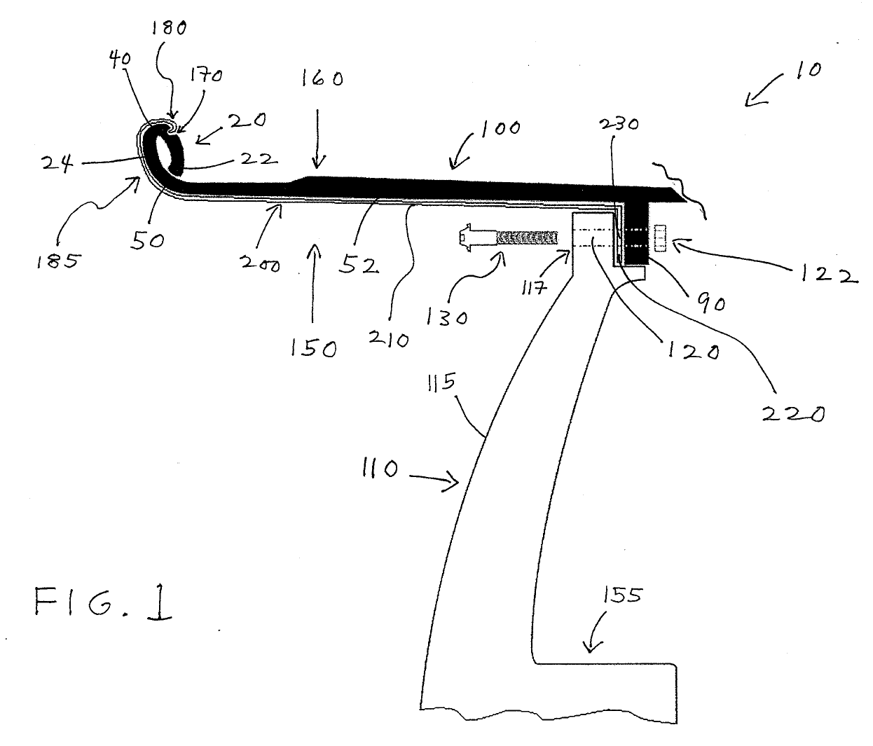

FIG. 1 is a cross sectional view of an example embodiment of a wheel 10 having a wheel component covering 200 attached thereto. As used herein, the term “rim flange” refers to a radially outwardly directed flange at or near an end region of the wheel. A wheel 10 has an outboard rim flange 20. The rim flange 20 generally has an inwardly facing surface 22 that is configured to interface with a radially inward, circular portion of a tire (not shown) to form an air-tight seal. The rim flange 20 generally also has an outwardly facing surface 24. The outboard rim flange 20 comprises a radially outward region 40 and a radially inward region 50.

The wheel 10 also includes a radially inwardly facing interior lip 52 that generally extends from the outboard side of the wheel to a wheel register 90. The wheel register 90 generally extends radially inwardly and provides a region for connection between the generally cylindrical wheel barrel 100 and the generally circular wheel center 110. In the illustrated embodiment, the wheel register 90 is a generally circular ring. In some embodiments, the wheel register 90 is a series of inwardly extending connection points that need not be connected circumferentially to each other. The wheel center 110 can comprise a plurality of spokes 115 and a hub 155 to which the axle of the vehicle can be attached by way of lug nuts (not shown).

In some embodiments, the spokes 115 can connect directly to the register 90, and in some embodiments the spokes 115 can connect in a radially outward region to a generally circular portion 117 on the wheel center 110, which in turn can connect to the register 90. In some embodiments, the wheel register 90 comprises a plurality of holes 120 through which a plurality of connectors, such as bolts 130, can be passed to removably secure the wheel center 110 to the wheel barrel 100. A plurality of securing structures, such as nuts 122, can be attached to the connectors on an inboard side of the register 90 to secure the wheel center 110 to the wheel barrel 100. In some embodiments, such as in one-piece wheels, the connectors may not be required to secure the center 110 to the wheel barrel 100, but may nevertheless be used to create a desired aesthetic appearance.

In some embodiments, the wheel center 110 and the wheel barrel 100 are formed as a single unitary piece and do not require bolts for attachment. Such wheels are sometimes referred to as “one-piece wheels” even though additional components may be attached to the unitary wheel barrel 100 and wheel center 110. In some embodiments, as shown, the wheel center 110 and wheel barrel 100 are formed separately and then attached. Such wheels are sometimes referred to as “two-piece wheels” or “three piece wheels” (when, for example, the wheel barrel 100 is itself formed of two separately formed pieces). The structures and features of the inventions disclosed herein can be applied to many different types of wheels, including one-, two-, and three-piece wheels.

A wheel component covering 200 is configured to be attached to the wheel 10. In some embodiments, the wheel component covering 200 can be made of a material that is different from, or gives the appearance of being different from, certain other components of the wheel 10. For example, in some embodiments, the wheel component covering 200 can be made of stainless steel and the wheel 10 can be made of aluminum. In some embodiments, some or all of the wheel 10 surfaces may be painted a certain color (such as black) and the wheel component covering 200 can be painted a different color or can remain unpainted. In some embodiments, the wheel component covering 200 can have a chrome finish (e.g., electroplated chromium) applied thereto.

In the illustrated embodiment, the wheel component covering 200 is generally a circular ring that is slightly smaller on the radially inward side than the wheel barrel 100 and that is slightly larger on the radially outward side than the wheel barrel 100. In this example, the wheel component covering 200 is able to be attached to the wheel barrel 100 on both of the radially inward 150 and radially outward 160 portions thereof. The wheel component covering 200 can have a degree of flexibility and can be substantially thinner than the wheel barrel 100 and/or the wheel center 110, since in some embodiments it is not required to support any weight from the vehicle or to impart structural integrity or rigidity to the wheel 10.

In some embodiments, the rim flange 20 includes an attachment structure, such as a groove 170, to assist in attaching a portion of the wheel component covering 200 to the wheel 10. The attachment structure, if included, can be positioned at any suitable point on the rim flange 20 or other region of the wheel. In some embodiments, it is desirable to avoid contact between the end of the wheel component covering 200 and the tire (not shown) to be installed on the wheel 10 but the end of the wheel component covering 200 can be positioned very closely to the tire wall to avoid a gap. In the illustrated example, the wheel component covering 200 includes a radially outwardly positioned connection portion, which is a hook-like portion 180 as shown, that is configured to interface and connect with the attachment structure of the rim flange 20. In some embodiments, a portion (e.g., the end) of the hook-like portion 180 can point generally radially inward, and in some cases can be curved to point generally in the outboard direction. As shown in FIG. 1, the connection portion 180 can be brought into contact with or inserted into the attachment structure 170 of the rim flange 20. In some embodiments, the thickness of the hook-like portion 180 can be approximately the same as or slightly smaller than the thickness of the groove 170 to provide a tight fit between these components that is less likely to move, rattle, or fall off when the wheel 10 rotates rapidly. A suitable lubricant, such as an oil, and/or a suitable sealant, such as a silicone gel, can be applied to either or both of the connection portion 180 and the attachment structure 170 to facilitate and/or secure the attachment between these components.

In the illustrated embodiment, the wheel component covering 200 also includes a generally arcuate outboard portion 185 that extends from the connection portion 180, around the outer facing surface 24 of the rim flange 20 and then in the inboard direction toward the interior lip 52 of the wheel barrel 100. The outboard portion 185 can have many different shapes. For example, it can be more angular with generally perpendicular sides, especially on wheels where the rim flange 20 of the underlying wheel has a corresponding shape with generally flat vertical and/or horizontal surfaces. In the illustrated example, the outboard portion 185 of the wheel component covering 200 generally surrounds the outboard rim flange 20. In some embodiments, this arrangement can not only provide an improved aesthetic appearance, but it can also provide increased strength and resilience in the outboard region of the wheel 10, which is often exposed to increased risk of contact with other objects that may result in scratching, chipping, or bending of this region of the wheel 10.

The wheel component covering 200 can further comprise a lip portion 210 that generally extends from the outboard portion 180 in the inboard direction toward the wheel center 110. In some embodiments, the lip portion 210 of the wheel component covering 200 is about the same length as the lip 52 of the wheel 10. In the illustrated embodiments, the lip portion 210 is generally horizontally oriented. The shape of the radially outward surface of the lip portion 210 can be configured to generally correspond to the radially inward surface of the wheel barrel 100 to form a tight fit that will generally not move, rattle, or separate when the vehicle wheel 10 is in motion. A chemical or mechanical connector, such as a sealant, adhesive, glue, screw, or bolts, can be applied at a suitable point between the lip portion 210, or any other part of the wheel component covering 200, and the wheel barrel 100, or any other part of the wheel 10. In some embodiments, as illustrated, there are no structures on the wheel component covering 200 extending radially across from one side of the covering 200 to the other side of the covering 200; rather, it can be essentially a ring-shaped structure.

In some embodiments, the lip portion 210 or the outboard portion 185 of the wheel component covering 200 can include an aesthetic design with bumps, etching, engraving, grooves, slits, or laser cutting, etc.

The wheel component covering 200 can also include an interior connection portion 220. In the illustrated embodiment, the interior connection portion 220 extends in a generally radially inward direction from the lip portion 210 of the wheel component covering 200. In the illustrated embodiment, the thickness of the wheel component covering 200 is generally uniform across the outboard portion 185, the lip portion 210, and the interior connection portion 220. The interior connection portion 220 is configured to attach to a portion of the radially interior region of the wheel. In the illustrated example, the interior connection portion 220 is positioned between the wheel register 90 and the radially outward portion of the spokes 115 and/or the generally circular portion 117 on the wheel center 110. The interior connection portion 220 can be attached to the wheel center 110 and/or to the register 90 near the radially inward surface of the wheel barrel 100. In some embodiments, the interior connection portion 220 can be positioned in front of the outboard side of the wheel register 90 and/or can include gaps or spaces for the spokes. In some embodiments, the interior connection portion 220 can include a series of holes 230 through which the connector 130 is passed after passing through the spokes 115 and/or circular portion 117 and before passing into the register 90.

In some embodiments, the wheel component covering 200 can be removable after installation. This may provide an advantage in allowing it to be replaced when damaged without having to replace the entire wheel 10 and/or in allowing the underlying wheel 10 to be more easily modified in some way (such as applying a paint) after the initial assembly of the wheel components.

In some embodiments, the wheel component covering 200 can give a one- or two-piece wheel the appearance of being a three-piece wheel because the wheel component covering 200 can give an integrated wheel barrel 100 the appearance of being constructed from two pieces. For example, the radially inwardly facing surface of the wheel barrel 100 that is on the outboard side of the wheel center 110 can be covered by the wheel component covering 200 and can appear to be made from a different material, and as a separate piece, than the portion of the wheel barrel 100 that is on the inboard side of the wheel center 110.

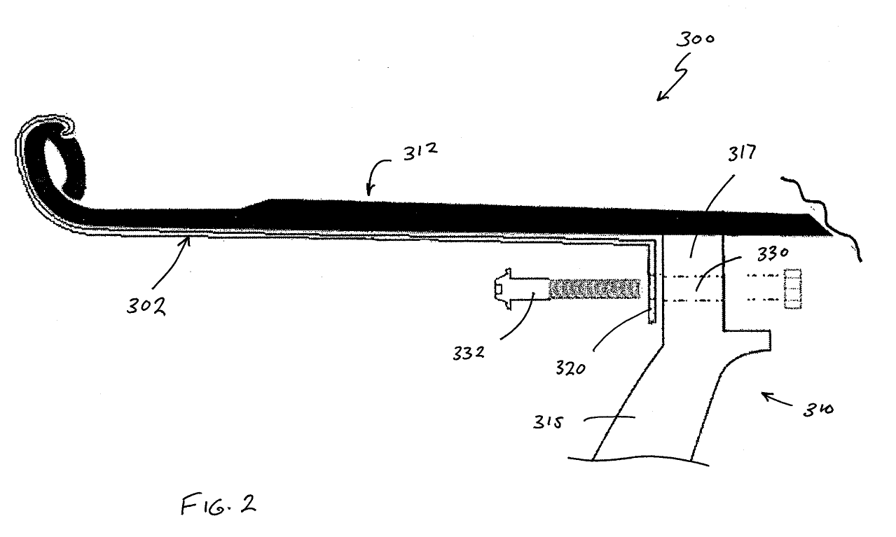

As shown in FIG. 2, in some embodiments, especially in certain one-piece wheel 300 embodiments, the interior connection portion 320 can be positioned on the outboard side of the radially outward portion of the spokes 315 and/or of the generally circular portion 317 on the wheel 300. The interior connection portion 320 can include holes 330 through which the connectors 332 can be passed before passing through the spokes 315 and/or circular portion 317. In some one-piece wheel embodiments, the connectors 332 are not required to secure the wheel center 310 to the wheel barrel 312, which can be formed as a single integrated piece. However, the connectors 332 can function to secure the interior connection portion 320 of the wheel component covering 302 to the radially outward portion of the spokes 315 and/or to the generally circular portion 317 of the wheel 300. The connectors 332 can also give the one-piece wheel the appearance of being a multi-piece wheel. Although the embodiment shown in FIG. 2 is a one-piece wheel, it will be understood that the interior connection portion 320 can be mounted onto the outboard side of the spokes 315 and/or of the generally circular portion 317 of a two- or three-piece wheel as well.

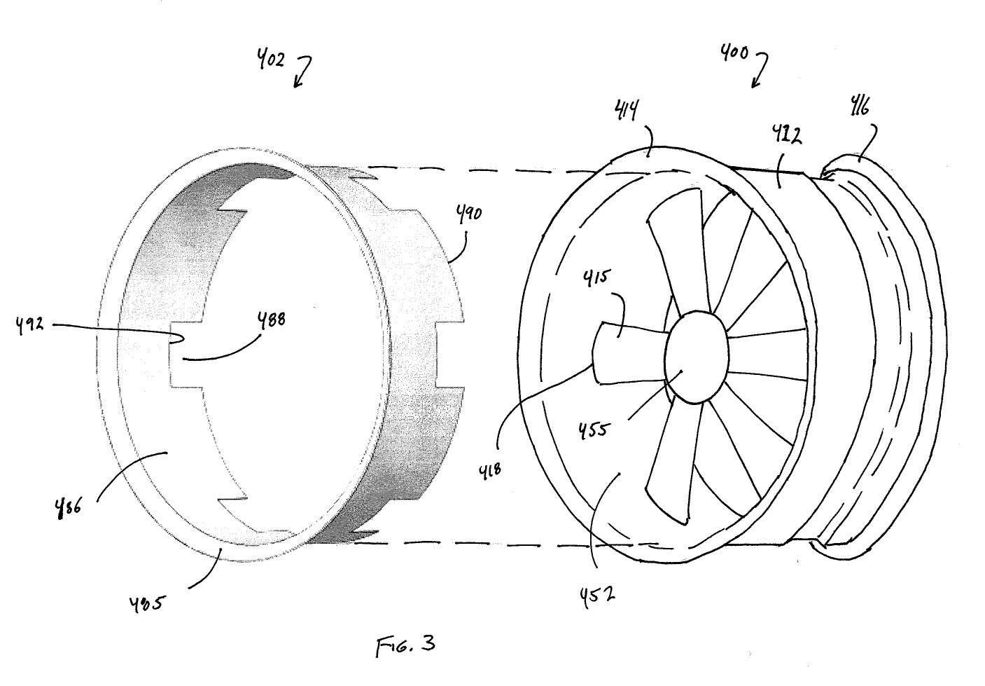

FIG. 3 is a perspective exploded view of a wheel 400 and a wheel component covering 402, which can be similar to, or the same as, the wheel 10 and wheel component covering 200 discussed in connection with Figure, or any other embodiment disclosed herein. The wheel 400 shown is a one-piece wheel, although multi-piece wheels can also be used. The wheel 400 can include a wheel barrel 412 with an outboard rim flange 414 positioned at the outboard end of the wheel barrel 412 and an inboard rim flange 416 positioned at the inboard end of the wheel barrel 412. A wheel center 410 can include a hub 455 connected to the radially inner surface 452 of the wheel barrel 412 by a plurality of spokes 415. In the illustrated embodiment, a six-spoke wheel is shown, but any other suitable number of spokes can be used (e.g., 3, 4, 5, 7, 8, etc.). The spokes 415 can connect to the wheel barrel 412 at junctions 418.

The wheel component covering 402 can include an outboard portion 485 configured to attach to the outboard rim flange 414 of the wheel 400. For example, the outboard portion 485 can be curved to generally track the curvature of the outboard rim flange 414 so that the outboard portion 485 snaps onto the outboard rim flange 414 when the wheel component covering 402 is inserted into the wheel 400. In some embodiments, the outboard portion 485 can be crimped onto the outboard rim flange 414. The outboard rim flange 414 can, in some cases, have a groove or a ridge configured to facilitate the attachment of the outboard portion 485 of the wheel component covering 402 to the outboard rim flange 414.

The wheel component covering can have a lip portion 486 extending from the outboard portion 485 in the inboard direction. When attached to the wheel 400, the lip portion 486 can extend along the radially inner surface 452 of the wheel barrel 412. In some embodiments, the lip portion 486 can extend generally parallel to the radially inner surface 452. In some embodiments, at least a portion of the lip portion 486 can abut against at least a portion of the radially inner surface 452 to prevent the wheel component covering from rattling during use. Gaps 488 can be formed in the inboard end of the lip portion 486, and the gaps 488 can be configured to receive the spokes 415. In the illustrated embodiment, six gaps 488 are provided to accommodate the six-spoke wheel 400.

When attached to the wheel 400, the inboard edge 490 of the wheel component covering 402 can be positioned further inboard than the spokes 415. The gaps 488 can have a depth that is about the same as the thickness of the spokes 415 at the location where the spokes 415 attach to the wheel barrel 412, so that the inboard edge 490 of the wheel component covering 402 can align substantially with the inboard side of the junction 418 between the spokes 415 and the wheel barrel 412. The gaps 488 can have a height that is greater than the thickness of the spokes 415 such that the inboard edge 490 of the wheel component covering 402 extends further inboard than the junction 418. In some cases, the gaps 488 can have a relatively shallow depth that is less than the thickness of the junction 418, so that the inboard edge 490 of the wheel component covering 402 is positioned between the outboard side and the inboard side of the junction 418.

As shown in FIG. 4, in some cases, the radially inner surface 452 of the wheel barrel 412 can include a step 419. When the wheel component covering 402 is attached to the wheel 400, the inboard edge 490 of the wheel component covering 402 can be positioned near or abut against the step 419. The step 419 can have a depth that is approximately the same as, or slightly larger than, the thickness of the lip portion 486 of the wheel component covering 402 such that the radially inner surface of the lip portion 486 aligns substantially flush with the radially inner surface 452 of the portion of the wheel barrel 412 that is inboard of the step 419. The wheel component covering can give the wheel 400 the impression of being a three-piece wheel in which the wheel barrel 412 is formed from two separate pieces joined together. The flush transition from the lip portion 486 of the wheel component covering 402 to the radially inner surface 452 of the wheel barrel 412 can make it less readily apparent that the wheel barrel 412 has an attachment overlaid thereon, further reinforcing the appearance that the barrel 412 is formed from two pieces.

In some embodiments, the step 419 can include a lip or overhang (not shown) configured to receive the inboard edge 490 of the wheel component covering 402 to facilitate the securing of the wheel component covering 402 to the wheel 400. A clip or snap fit mating structures can be formed on the step 419 and/or on the inboard edge 490 of the wheel component covering 402 to facilitate the securing thereof.

The radially inner surface 452 of the barrel 412 and/or the lip portion 486 of the wheel component covering 402 can be tapered slightly such that the radius thereof decreases in the inboard direction. The lip portion 486 can be generally straightOwalled (e.g., not tapered) or can be taped less than the radially inner surface 452 of the wheel barrel 412 such that, as the wheel component covering 402 is inserted into the wheel 400, the radially outer surface of the lip portion 486 can press against the radially inner surface 452 of the wheel barrel 412 to facilitate the securing thereof. The lip portion 486 can be formed with a sufficiently small thickness so that the lip portion 486 can be deformed somewhat upon insertion so as to impart a force against the radially inner surface 452 of the wheel barrel 412 to secure the wheel component covering 402 to the wheel 400 by a friction fit. In some embodiments, a lubricant can be applied to allow the wheel component covering 402 to be inserted into the wheel 400.

Various other methods for securing the wheel component covering 402 to the wheel 400 can be used. For example, screws (not shown) can pass through radial holes (not shown) in the lip portion 486 and can engage radial bores (not shown) formed in, but not passing through, the wheel barrel 412. The wheel component covering 402 can have one or more interior connection portions (not shown) that extend radially inwardly approximately 90° (e.g., about 75° to about 105°) from the lip portion 486. The interior connection portions can extend, for example, from the outboard ends 492 of the gaps 488 and can have holes to allow bolts to secure the interior connection portions to holes on the radially outer portions of the spokes 415. The interior connection portions can extend from the portions of the lip portion 486 between the gaps 488 and can secure to a register or lip or generally circular portion of the wheel center, for example, at locations between the spokes.

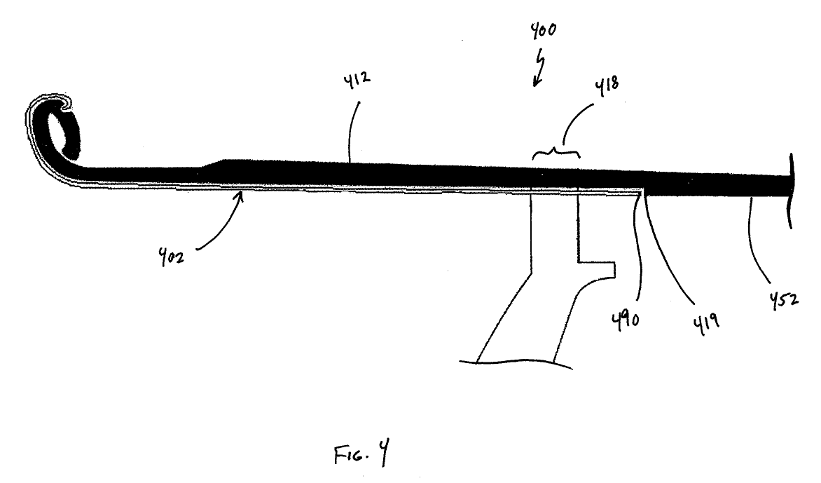

FIG. 5 is a perspective view of another example embodiment of a wheel component insert 502, which can be similar to, or the same as, the wheel component insert 402 or any other suitable wheel component insert disclosed herein. The wheel component insert 502 can include an outboard portion 585 configured to attach to an outboard rim flange of a wheel, and a lip portion 586 extending in the inboard direction from the outboard portion 585. The wheel component insert 502 can have gaps 588 configured to receive spokes of the wheel. Tabs 582 can be formed between the gaps 588. Fold lines 580 can be formed on the tabs 582 such that at least a portion of the tabs 582 can be bent or turned radially inwardly to form interior connection portions 520 (as seen, for example, in FIG. 2). The interior connection portions 520 can be turned or otherwise formed to create an angle of at least about 75° and/or no more than about 105°, and in some cases of about 90° with respect to the surface of the lip portion 586. The tabs 582 can include holes 584 for receiving a bolt or other connector for securing the tabs 582 to the wheel. In some embodiments, the wheel can include a lip or register or a generally circular portion of the wheel center that extends between the spokes, and the register can have holes that align with the holes 584 such that a bolt can be passed therethrough.

The tabs 582 can be positioned on the outboard side of the register (e.g., as shown in FIG. 2). The position of the fold lines can depend on the shape of the wheel and especially the configuration of the spokes and register. In some cases, the register can extend substantially around the entire circumference of the wheel. The fold lines 580 can align with the outboard ends 592 of the gaps 588, such that substantially the entire tab 582 bends down to become the interior connection portion 520. Thus, outboard ends 592 of the gaps 588 and the fold lines 580 can be positioned adjacent to or abut against the outboard side of the register, and the gaps 588 can receive the spokes such that the bent tabs 582 do not obscure the radially outer portions of the spokes. In some embodiments, the wheel component covering 502 can be formed (e.g., molded) with the interior attachment portions 520 already bent to the desired position.

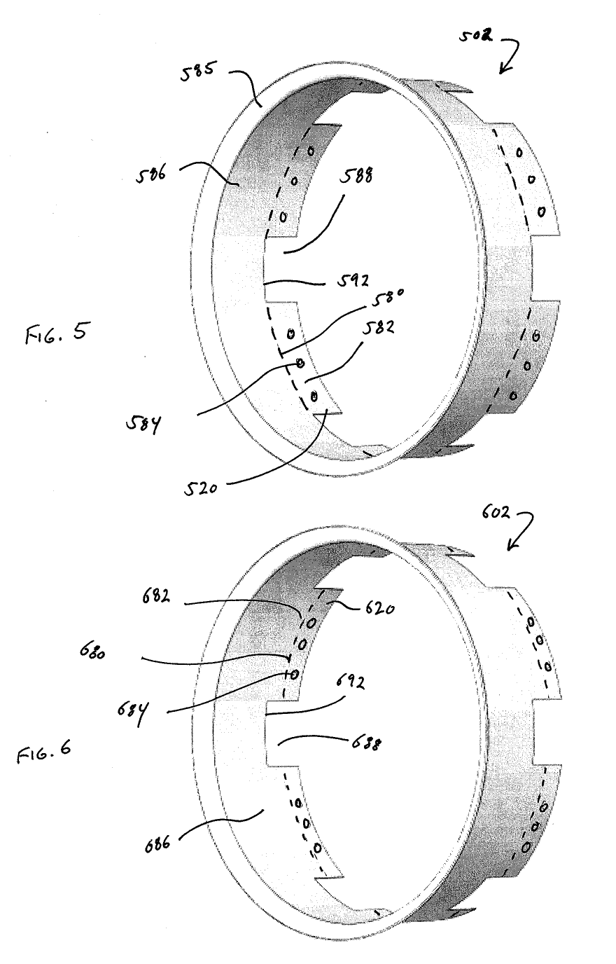

In some embodiments, the register pieces that extend between the spokes can be inset in the inboard direction from the outboard edges of the spokes. FIG. 6 shows a wheel component covering 602 which can be similar to, or the same as, the wheel component covering 502 or any other suitable wheel component covering disclosed herein. The fold lines 680 can be positioned inboard of the outboard ends 692 of the gaps 688, for example along the center of the tabs 682. When the tabs 682 are bent or folded along the fold lines 680 to form the interior connection portions 620, the fold lines 680 can be positioned adjacent to or abut against the outboard side of the register, and the gaps 688 can receive the spokes such that a portion of the tabs 682 are positioned further inboard than the outboard side of the junction between the spokes and the wheel barrel.

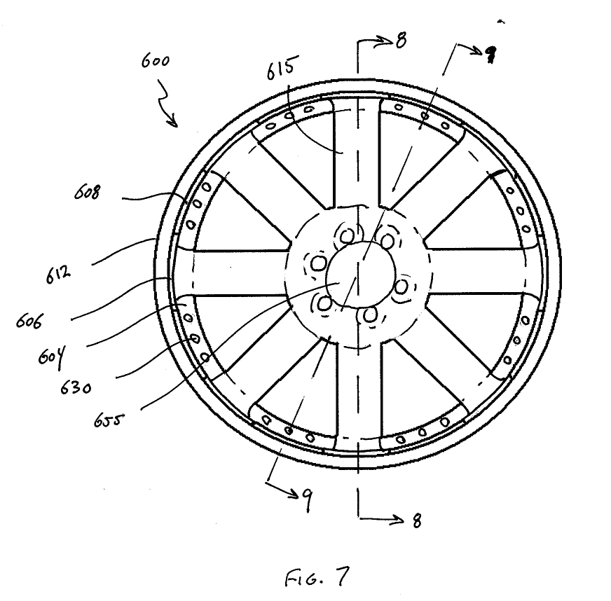

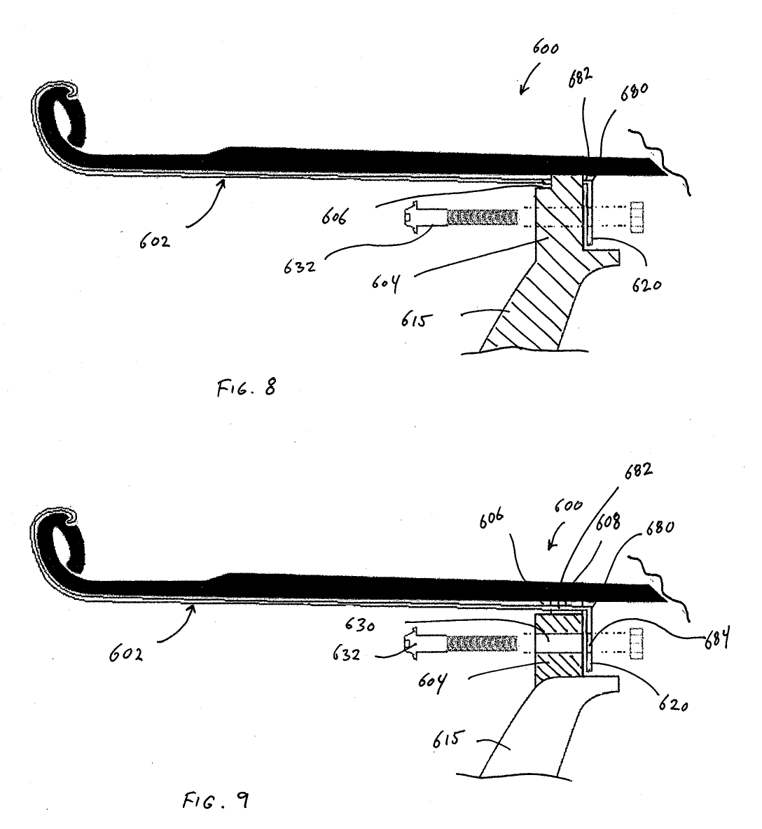

With further reference to FIG. 6 and with reference to FIGS. 7-9, the interior connection portions 520 of the tabs 582 can attach to the inboard side of the register 604. FIG. 7 is a side view of an example embodiment of a wheel 600 taken from the outboard side of the wheel 600. FIG. 8 is a cross sectional view of the wheel 600 taken along the line 8-8 of FIG. 7 along the center of one of the spokes 615, with the wheel component covering 602 attached to the wheel 600. FIG. 9 is a cross sectional view of the wheel 600 taken along line 9-9 of FIG. 7, with the wheel component covering 602 attached to the wheel 600.

The wheel 600 can be, for example, a one-piece wheel which is configured to appear to be a three-piece wheel. The wheel 600 can have a hub 655 that is connected to the wheel barrel 612 by a plurality of spokes 615. A register 604 can extend between the spokes 615, or can extend along substantially the entire circumference of the wheel barrel 612. A groove 606 can be formed at the base of the register 604. The grove 606 can provide the appearance that the spokes 615 and register 604 are not integrally formed with the wheel barrel 612. The groove 606 can provide the appearance that the register 604 is a generally circular portion of a wheel center piece that is secured to a register on the wheel barrel (as is the case in many multi-piece wheels).

Holes 608 can be formed through the base if the register 604 at locations between the spokes 615. The tabs 682 of the wheel component covering 602 can pass through the holes 608 in the register so that the fold lines 680 are positioned at or near the inboard side of the register 604. Thus, the interior connection portions 620 of the wheel component covering 602 can be attached to the inboard side of the register 604 by bolts 632 or other connectors passed through holes 630 in the register and holes 684 in the interior connection portions 620.

Thus, the one-piece wheel 600 can have the appearance of being formed from three separate pieces: a wheel center ending at the groove 606, an outboard wheel barrel piece formed of a first material (the wheel component covering), and an inboard wheel barrel piece formed of a second material. Although the wheel 600 is shown as a one-piece wheel, it will be understood that the wheel 600 could also be a multi-piece wheel wherein the wheel component covering attaches to the inboard side of the register.

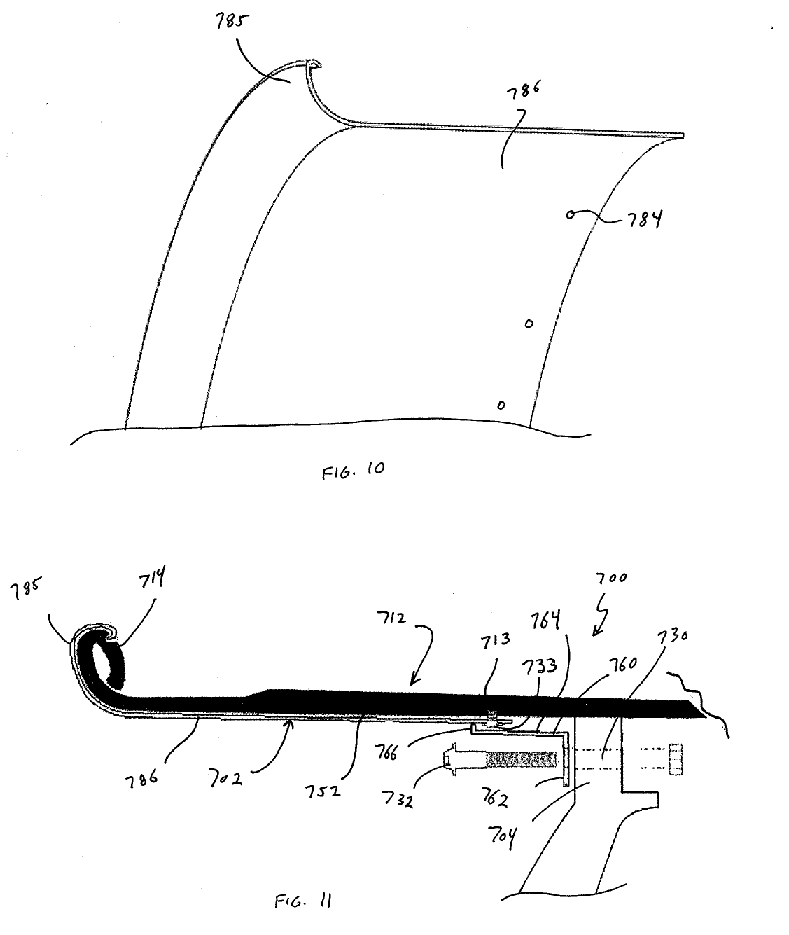

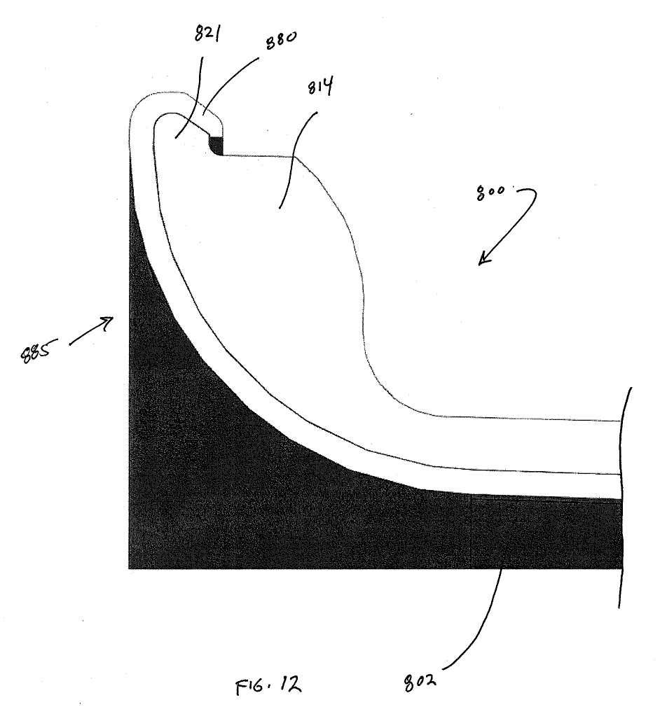

FIG. 10 is a perspective, cross sectional view of another example embodiment of a wheel component covering 702 which can be similar to, or the same as, the other wheel component covering embodiments disclosed herein. FIG. 11 is a cross sectional view of the wheel component covering 702 attached to a wheel 700. The wheel component covering 702 can include an outboard portion 785 configured to attach to an outboard rim flange. A lip portion 786 can extend along the radially inner surface 752 of the wheel barrel 712. One or more holes 784 can be formed radially through the wall of the lip portion 786. The wheel barrel 712 can have corresponding one or more bores 713 formed in the radially inner surface 752 of the barrel 712. The bores 713 can be threaded and can pass only partially through the wall of the wheel barrel 712 such that when a tire is mounted to the wheel 700, air does not escape through the bores 713. A bolt or screw 715 can pass through the hole 784 and engage the bore 713 to secure the lip portion 786 of the wheel component covering 702 to the barrel 712 of the wheel 700.

A cover 760 can be used to cover and conceal the screw 733. The cover can have an attachment portion 762 configured to align with the register 704 or other portion of the wheel 600. The attachment portion 762 can have holes to receive bolts 732 that also pass through holes 730 in the register. The attachment portion 762 can attach to the outboard or inboard sides of the register 704, or in a multi-piece wheel, the attachment portion 762 can be sandwiched between the register and the wheel center (see e.g., FIG. 1) or attached to the outboard side of the wheel center. A lip portion 764 can extend in the outboard direction from the attachment portion 762. The lip portion 764 can cover the screw 733 and can extend generally parallel to the radially inner surface 752 of the wheel barrel 712. An end piece 766 can be positioned at the outboard end of the cover 760. The end piece 766 can abut against, or be positioned adjacent to, the lip portion 786 of the wheel component covering 702. In some embodiments, the covering 760 can be formed of the same material as the wheel component covering 702 such that it appears to be an integral part of the wheel component covering 702. Thus, the end piece 766 can appear to be merely a step or turn in the wall of the wheel component covering 702. In some embodiments, the end piece 766 can be angled with respect to the lip portion 786 of the wheel component covering 702 (rather than generally parallel as shown in FIG. 11), to make the transition between the wheel component covering 702 and the cover 760 less apparent. Thus, the cover 760 can appear to be a mere tapering of the lip portion 786 of the wheel component covering 702. In some embodiment, the end piece 766 can be omitted and the lip portion 764 of the cover 760 can be angled to that the outboard end thereof lies adjacent to, or abuts against, the wall of the wheel component covering 702.

FIG. 12 is a partial cross sectional view of another embodiment of a wheel 800 and wheel component covering 802, which can be similar to, or the same as the other embodiments thereof disclosed herein. The wheel 800 can include an outboard rim flange 814 that has an auxiliary ridge 821 positioned at the outboard end thereof. The wheel component covering 802 can include an outboard portion 885 that has a shape that corresponds substantially to the outboard side of the outboard rim flange 814. The outboard portion 885 can include a hook-like portion 880 with a shape that corresponds substantially to the auxiliary ridge 821. In some embodiments, a portion (e.g., the end) of the hook-like portion 880 can point generally radially inward. The hook-like portion 880 can snap onto the auxiliary ridge 821 when the wheel component covering 802 is inserted into the wheel 800. The hook-like portion 880 can be crimped onto the auxiliary ridge 821. The hook-like portion 880 can be press fit onto the auxiliary ridge 821.

Although these inventions have been disclosed in the context of a certain preferred embodiment and examples, it will be understood by those skilled in the art that the present inventions extend beyond the specifically disclosed embodiment to other alternative embodiments and/or uses of the inventions and obvious modifications and equivalents thereof. In particular, while the present mounting arrangement has been described in the context of preferred embodiments, the skilled artisan will appreciate, in view of the present disclosure, that certain advantages, features, and aspects of the mounting arrangement may be realized in a variety of other applications, some of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiment described above, but should be determined only by a fair reading of the claims as ultimately published in one or more publications or issued in one or more patents.

The following is claimed:

1. A wheel configured to be mounted onto a vehicle, the wheel comprising:
a wheel barrel comprising a radially inner surface, an inboard side, and an outboard side;
an outboard rim flange positioned on the outboard side of the wheel barrel;
a wheel center comprising a hub and a plurality of spokes connecting the hub to the wheel barrel; and
a wheel component covering comprising:
an outboard portion secured to the outboard rim flange;
a lip portion extending from the outboard portion along the radially inner surface of the wheel barrel toward the inboard side of the wheel barrel; and
a plurality of gaps formed in the lip portion, the plurality of spokes received by the plurality of gaps.

2. The wheel of claim 1, wherein an inboard edge of the lip portion is positioned further inboard than an outboard side of a junction between the wheel center and the wheel barrel.

3. The wheel of claim 1, wherein an inboard edge of the lip portion is positioned further inboard than an inboard side of a junction between the wheel center and the wheel barrel.

4. The wheel of claim 1, wherein the wheel component covering further comprises an interior attachment portion configured align with a register of the wheel, and wherein connectors pass through holes in the interior attachment portion and through holes in the register to secure the interior attachment portion to the register.

5. The wheel of claim 4, wherein the interior attachment portion is secured to the outboard side of the register.

6. The wheel of claim 4, wherein the interior attachment portion is secured to the inboard side of the register.

7. The wheel of claim 1, wherein one or more bores are formed in the radially inner surface of the wheel barrel, and wherein one or more holes are formed in the lip portion of the wheel component covering, and wherein one or more connectors pass through the holes to engage the one or more bores to secure the lip portion to the wheel barrel.

8. The wheel of claim 7, further comprising a covering that extends over the one or more connectors.

9. The wheel of claim 8, wherein the covering comprises an attachment portion secured to a register of the wheel.

10. The wheel of claim 1, wherein the wheel barrel and the wheel center are integrally formed.

11. The wheel of claim 1, wherein the wheel barrel is separately formed from the wheel center.

12. A wheel component covering comprising:
an outboard portion configured to attach to an outboard rim flange of a wheel;
a lip portion configured to extend from the outboard portion along a radially inner surface of a wheel barrel of the wheel toward the inboard side of the wheel barrel; and
a plurality of gaps formed in the lip portion, the plurality gaps configured to receive a plurality of spokes of the wheel.

13. The wheel of claim 12, further comprising an interior attachment portion configured to align with a register of the wheel, wherein the interior attachment portion includes holes for a connector to pass through to secure the interior attachment portion to the register.

14. The wheel of claim 12, further comprising one or more holes are formed in the lip portion of the wheel component covering, the one or more holes configured to align with one or more bores formed in the radially inner surface of the wheel barrel so that one or more connectors can pass through the holes to engage the one or more bores to secure the lip portion to the wheel barrel.

15. A method of attaching a wheel component covering to a wheel, the method comprising:
providing a wheel, the wheel comprising:
a wheel barrel comprising a radially inner surface, an inboard side, and an outboard side;
an outboard rim flange positioned on the outboard side of the wheel barrel; and
a wheel center comprising a hub and a plurality of spokes connecting the hub to the wheel barrel;
attaching an outboard portion of the wheel component covering to the outboard rim flange;
positioning a lip portion of the wheel component covering along the radially inner surface of the wheel barrel; and
receiving the plurality of spokes into a plurality of gaps formed in the lip portion of the wheel component covering.

16. The method of claim 15, further comprising positioning an inboard edge of the lip portion further inboard than an outboard side of a junction between the wheel center and the wheel barrel.

17. The method of claim 15, further comprising positioning an inboard edge of the lip portion further inboard than an inboard side of a junction between the wheel center and the wheel barrel.

18. The method of claim 15, further comprising:
aligning an interior attachment portion with a register of the wheel; and
passing connectors through holes in the interior attachment portion and through holes in the register to secure the interior attachment portion to the register.

19. The method of claim 18, wherein the interior attachment portion is secured to the outboard side of the register.

20. The method of claim 18, wherein the interior attachment portion is secured to the inboard side of the register.

21. The method of claim 15, further comprising:
aligning one or more bores formed in the radially inner surface of the wheel barrel with one or more holes formed in the lip portion of the wheel component covering; and
passing one or more connectors through the holes to engage the one or more bores to secure the lip portion to the wheel barrel.

22. The method of claim 21, further comprising placing a covering over the one or more connectors.

23. The method of claim 22, further comprising attaching an attachment portion of the covering to a register of the wheel.

24. The method of claim 15, wherein the wheel barrel and the wheel center are integrally formed.

25. The method of claim 15, wherein the wheel barrel is separately formed from the wheel center.
